(19) United States
(12) Patent Application Publication
(10) Pub. No.: US 2003/0234979 A1
(43) Pub. Date: Dec. 25, 2003

(54) X-Y stage for two-photon microscope

(75) Inventors: Muming Poo, Shanghai (CN); Zhuan Zhou, Shanghai (CN); Shumin Duan, Shanghai (CN); Xinqiao He, Shanghai (CN); Qian Hu, Shanghai (CN)

Correspondence Address: CROWELL & MORING LLP, INTELLECTUAL PROPERTY GROUP, P.O. BOX 14300, WASHINGTON, DC, 20044-4300, US

(73) Assignee: Shanghai Institutes for Biological Sciences, Shanghai (CN)

(21) Appl. No.: 10/463,429

(22) Filed: Jun. 18, 2003

(30) Foreign Application Priority Data
Jun. 21, 2002 (CN) 02112182.6

(51) Int. Cl. G02B 21/00

(52) U.S. Cl. 359/393; 359/368; 359/391; 359/392

(57) ABSTRACT

The invention is related to a mechanical x-y-axis adjustable stage, which is designed for microscopic electro-physiological studies. The stage adopted a three-layer flat-slab structure. The up-most layer was a bearing layer on which other equipment could be mounted. The middle layer and bottom layer were guide layers, and rails for x-axis or y-axis guiding were installed. In order to move the top layer smoothly along two-dimension relative to the bottom layer, the three layers were jointed using grooved rails. By moving the top layer accordingly along the x-axis and y-axis, biological sample (animal/cells) as well as other instruments such as electrophysiological probes and manipulators could be moved smoothly and flexibly, and specific visual fields could be defined without moving the complex microscope system as well as other optical components. Therefore, the present invention has broad application values, for example two-electrodes electrophysiological recordings.

### CROSS REFERENCE TO RELATED APPLICATIONS

This application claims the priority of Patent Document No. 02112182.6, filed in People's Republic of China on Jun. 21, 2002, the disclosure of which is expressly incorporated by reference herein.

### FIELD OF THE INVENTION

The invention is related to a unique mechanical two-dimension (horizontal) adjustable stage that can be used in microscopic electro-physiological studies.

### BACKGROUNDS OF THE INVENTION

In the electro-physiological studies of brain slice and cultured cells, microscope stages are needed to mount micro-manipulators as well as other equipment. Currently, most of the microscope stages (e.g. the XY-Gibralter stage from Burleigh Company) designed for this purpose adopted a fixed stage design in which the stage was immobilized while the microscope was installed on a horizontal two-dimensional adjustable stage. To observe cells in different visual fields, the microscope had to be moved by turning micro-screws in the stage. The limitation of such design is that sometimes it is difficult to move the microscope, for example in the case of a two-photon laser scan microscope.

Most modern biological microscopes are attached with various mechanical stages that can move observed samples and there is no need to move the microscopes. However, the precision as well as the weight they can bear is all limited, and it is difficult to mount a micromanipulator on these kinds of stages. Further, the stages are not large enough for mounting several micro-manipulators. In other words, these stages do not meet the needs of electro-physiology studies.

### SUMMARY OF THE INVENTION

The invention is to provide an external x-y-axis adjustable stage, adopting microscope-fixing and stage-moving strategy to change visual fields in a large-sized instrument such as a microscope, so that cells in different visual field can be observed and impaled by electrodes simultaneously.

To achieve this goal, our solution is to adopt an x-y-axis adjustable microscope stage. The stage is characterized by a three-layer flat-slab structure. On the top there is a bearing layer, and in the middle and bottom there are guide layers. The layers are jointed through grooved rails, and the top-bearing layer can be controlled to make horizontally two-dimensional move relative to the bottom layer.

In order to make the top bearing layer move precisely, smoothly, and stably, the three layers are jointed through grooved rails and advanced and retreated by using micro-screws and springs.

The advantages from the design are the followings. By using the three-layer movable flat-slab structure, the flexible movement of the visual fields is achieved by moving the top-bearing layer of the stage without the need to move the microscope. By using grooved rails to joint the layers and using micro-screws and springs to push and pull the middle and top layers, it achieves precise, smooth, and flexible movements. In the mean time, the large area of the stage provides enough space for mounting several micromanipulators and other equipment. For the electro-physiological studies of brain slice or cultured cells or other biological samples, the stage invented here can mount several micromanipulators and electrodes, and cells in different visual fields can be recorded simultaneously. The stage can be mounted on a large instrument such as microscope. The invention makes it possible to do experiments involving simultaneous electro-physiological recoding and two-photo excitation, and has an important application value. An example of successful biological experiments using this invention is illustrated in FIG. 4.

### BRIEF DESCRIPTION OF THE DRAWINGS

FIG. 1. Illustration of the structure.

FIG. 2. An instance of an application.

FIG. 3. A three-dimension view of the invention.

FIG. 4. An example of successful biological experiments using this invention

### DETAILED DESCRIPTION OF THE PREFERRED EMBODIMENT

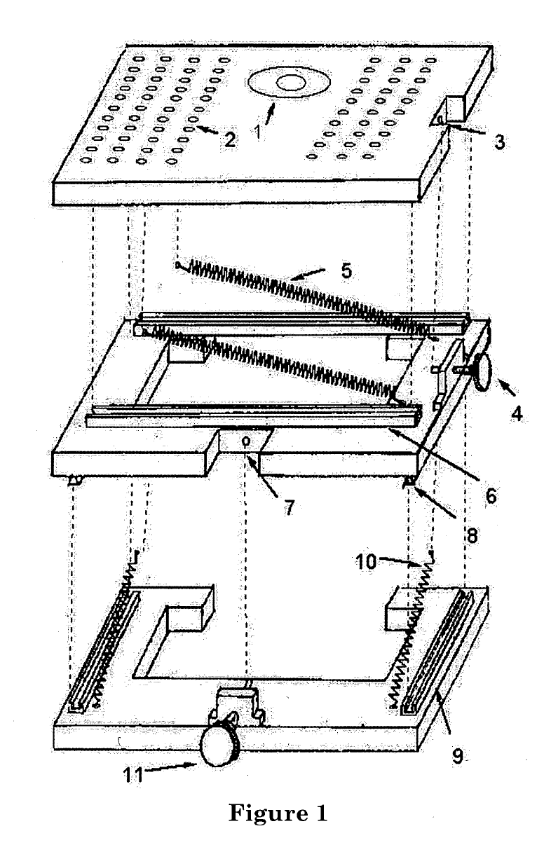

As shown in FIG. 1 and FIG. 3, a mechanical x-y-axis adjustable stage (12), the top layer is the bearing layer with screw holes (2) and a sample carrier (1). There is a concave on its right side, and a small steel x-axis pushing ball (3) sits inside of the concave. There are two x-direction rails on the undersurface of the layer.

The middle layer is the x-axis guide layer, and there are two x-direction grooves (6). On the right side, there is an extrusion facing the concave of the top layer, and the concave accepts the extrusion. A micro-screw pusher (4) traverses the extrusion and withstands the small pushing ball (3). On the right side of the guide groove, two springs (5) are fixed. The other sides of the springs (5) are fixed to the undersurface of the top layer. There is also one concave in the front of the middle layer, and a small steel y-axis pushing ball (7) sits inside of the concave. There are two y-direction rails (8) on the undersurface of the layer.

The bottom layer is also a guild layer. There are two y-axis grooves (9) sit facing the two y-direction rails (8) in the middle layer. Two parallel springs (10) are fixed to the one side of the grooves (9). The other sides of the springs (10) are fixed to the undersurface of the middle layer. In front of the bottom layer, there is an extrusion facing the concave of the middle layer, and the concave accepts the extrusion. A micro-screw pusher (11) traverses the extrusion and withstands the small pushing ball (7).

The bottom layer is fixed on a surface, e.g. an experiment table, by four support rods (FIGS. 3, 13).

The invention adopts a three-layer flat-slab structure including three parallel layers: the top layer, the middle layer, and the bottom layer. The bottom layer is fixed on the experimental table through four support rods. By screwing the micro-screw (11) of the bottom layer against the y-axis pushing ball (7), the middle layer can move smoothly along the y-axis. The springs (10) can pull back the middle layer along the y-axis grooves (9). The springs (10) can also give tense against the micro-screw (11) and make the middle layer move smoothly along y-axis. The top layer moves in the similar way. The micro-screw (4) is used to push the top layer, and the springs (5) are used to pull back the top layer. So, the top layer can also move smoothly along x-axis grooves (6) in the middle layer.

In summary, by coordinated movement of the three layers, the top layer can be moved two-dimensionally horizontally relative to the experimental table. By using the micro-screw to push and the springs to pull back, the layers can be controlled to move smoothly. Through the two-dimension movement of the layers, the top-bearing layer can be controlled to move accordingly relative to the objective, and specific visual fields can be defined. Experimental samples and electrode manipulators can be moved flexibly without moving the microscopes. The invention provides important application values.

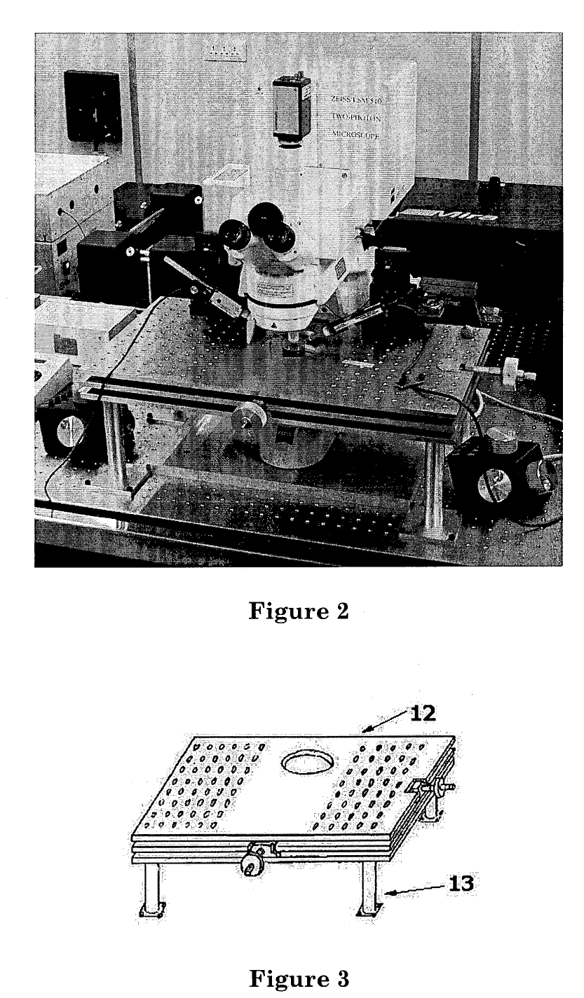

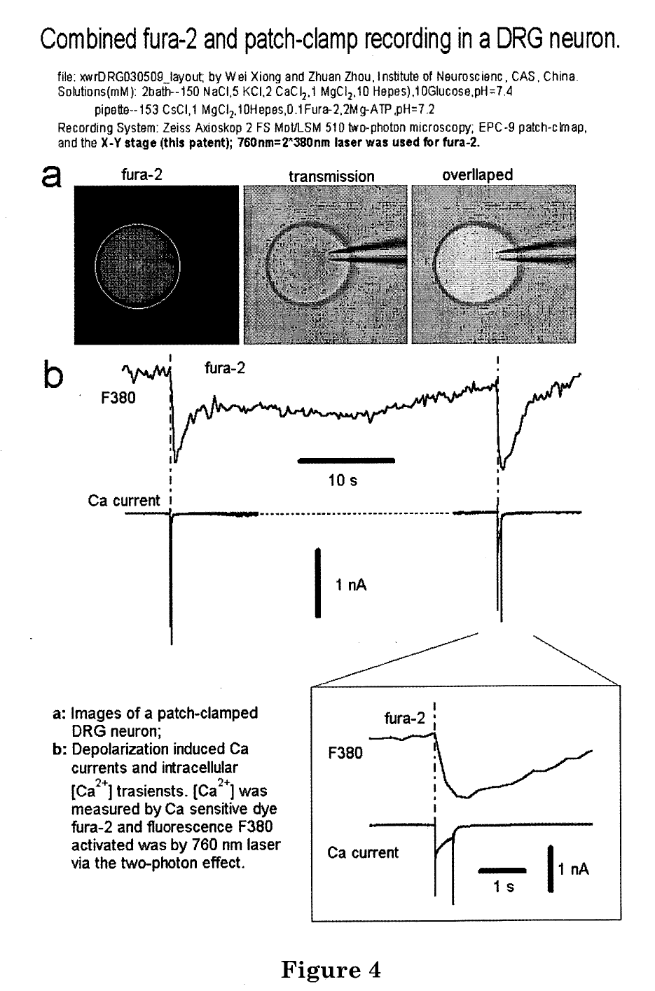

A photograph of an application using the x-y-axis adjustable stage was presented in FIG. 2.

In one embodiment, the x-y-axis stage is a microscope stage. In another embodiment, the stage is mounted on any instrument with size similar to the microscope, for example laser scanning multiphoton microscope, confocal microscope, conventional overhead microscope, invert microscope and stereo microscope.

In one embodiment, the present invention can hold biological samples and/or physical devices. The biological samples includes but are not limited to, cell, tissue or organ as well as whole animal. The physical devices include but not limited to electrodes. In yet another embodiment, the present invention is designed for electro-physiological studies, wherein an instrument such as a microscope is adopted a three-layer flat-slab structure.

The description above is only a preferable application instance of the invented x-y-axis adjustable microscope stage. The description should not limit the declared right of the invention, i.e. all modifications based on the invention with no material change should all be protected by the patent.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is

1. An x-y-axis adjustable microscope stage comprising a three-layer flat-slab structure, wherein the top layer is a bearing layer, and the middle layer and bottom layer are guide layers, and wherein the three layers are further jointed through grooved rails to achieve smooth and flexible two-dimension horizontal movements of the top bearing layer relative to the bottom layer.

2. The adjustable stage according to claim 1, wherein said stage which comprises three layers is jointed through grooved rails, micro-screws and springs as its advance and retreat components to achieve flexible, precise, and smooth movements.

3. The adjustable stage according to claim 1, wherein said stage is for holding a biological sample and/or physical devices.

4. The adjustable stage according to claim 3, wherein said stage is designed for electrophysiological studies which are used to position electrodes to manipulate the biological sample under the microscope monitoring.

5. The adjustable stage according to claim 2, wherein said stage is for holding a biological sample and/or physical devices.

6. The adjustable stage according to claim 5, where in said stage, is for electrophysiological studies, which are used to position electrodes to manipulate the biological sample under the microscope monitoring.

7. A mechanical x-y-axis adjustable stage comprising a top layer, a middle layer and a bottom layer,
the top layer being a bearing layer having screw holes and a sample carrier, a first notch on one edge inside which notch sits an x-axis pushing ball, and two x-axis rails on the undersurface of the top layer;
the middle layer being an x-axis guide layer, having two x-direction groove facing and fitting into the x-axis rails of the top layer, a first extrusion on the edge corresponding to the edge of the top layer having the first notch, said first extrusion facing and fitting into the first notch; a micro-screw pusher which traverses the extrusion and withstands the x-axis pushing ball; two springs fixed in a parallel manner along side the x-direction grooves at one end on the middle layer at the edge near the notch, and at the other end fixed to the undersurface of the top layer; a second notch on an edge perpendicular to the edge where the protrusion is located, inside which second notch sits a y-axis pushing ball; and two y-direction rails on the undersurface of the layer, and
the bottom layer being also a guide layer, having two y-axis grooves facing and fitting into the two y-direction rails of the middle layer, a second extrusion facing and fitting into the second notch of the middle layer, a micro-screws pusher which traverses the second extrusion and withstands the y-axis pushing ball, and two parallel springs along side the y-axis grooves fixed at one end near the edge where the micro-screw pusher, and at the other end to the undersurface of the middle layer,
and wherein the bottom layer is optionally fixed on a supporting surface.
